(19) United States
(12) Patent Application Publication
(10) Pub. No.: US 2017/0275160 A1
(43) Pub. Date: Sep. 28, 2017

(54) ELECTRO-MAGNETIC RESONANCE APPARATUS FOR MOLECULAR, ATOMIC, AND CHEMICAL MODIFICATION OF WATER

(71) Applicant: Carter International, LLC, Houston, TX (US)

(72) Inventors: Marcos De La Monja Carter, Guadalajara (MX); Humberto Martin Vega Poucel, Guadalajara (MX); Santiago De La Monja Avila, Guadalajara (MX)

(73) Assignee: Carter International, LLC, Houston, TX (US)

(21) Appl. No.: 15/468,113

(22) Filed: Mar. 24, 2017

Related U.S. Application Data
(60) Provisional application No. 62/313,497, filed on Mar. 25, 2016.
(60) Provisional application No. 62/362,549, filed on Jul. 14, 2016.
(60) Provisional application No. 62/382,684, filed on Sep. 1, 2016.

(51) Int. Cl. C01B 3/04; B01J 19/08; C01B 13/02; B01J 7/02

(52) U.S. Cl. CPC C01B 3/042; B01J 7/02; B01J 19/087; C01B 13/0207; B01J 2219/0801; B01J 2219/0862; B01J 2219/0877

(57) ABSTRACT

An electromagnetic resonance apparatus for molecular, atomic, and chemical modification of water is provided. The apparatus includes a water container, a resonance induction cell tower, an electronic control unit, a 12-volt power source, a DC to AC power inverter, and a pressure vessel for storing produced hydrogen gas. An electronic control unit is used to provide vibrational energy to the cell tower to facilitate water decomposition.

This application claims the benefit of U.S. Provisional Patent Application Ser. No. 62/313,497, filed Mar. 25, 2016, U.S. Provisional Patent Application Ser. No. 62/362,549, filed Jul. 14, 2016, and U.S. Provisional Patent Application Ser. No. 62/382,684, filed Sep. 1, 2016, the entirety of each being incorporated by reference herein.

### FIELD OF THE INVENTION

Embodiments of the present invention generally relate to apparatus and processes for producing a sustainable energy source—hydrogen gas—in an environmentally manner. In one embodiment, electro-magnetic resonance is used to efficiently decompose water into hydrogen and oxygen.

### BACKGROUND OF THE INVENTION

One of the most critical issues industrial nations must address is producing energy without generating greenhouse gases. Many common energy production methods generate energy at relatively low cost. Unfortunately, common energy production methods based on burning hydrocarbon release greenhouse gases and other pollutants into the atmosphere, which is proven to contribute to global warming. To combat this trend, many industries have turned to alternative fuels and other methods for generating electricity. Although a substantial progress has been made, many technologies are in their infancy and require more research and development to fully realize their potential.

Hydrogen is the cleanest burning of gases with a net heating value of over 51,000 BTU per pound (LHV). Hydrogen has been used in combustion engine generators, steam power cycles on an industrial scale, and in hydrogen fuel cell batteries. However, hydrogen as a fuel has been uncompetitive with hydrocarbons due to the high cost of production. Polymer electrolyte membrane (PEM) electrolysis, a common method of producing hydrogen from water cost between four dollars and six dollars per kilogram of hydrogen produced. This stems from the fact that the electricity needed to drive the electrolysis process costs roughly the same as the energy value of the produced hydrogen. The energy used for electrolysis is obtained from pollution-producing hydrocarbons. Storing and transporting hydrogen also poses various issues and increases costs, which is not the case with hydrocarbons. Hydrogen can be produced from methane, but the process is not ideal because it also produces carbon dioxide. Further, the cost associated with methane-based hydrogen production is over three dollars per kilogram of hydrogen produced.

To address the inefficiencies of common electrolysis, some have looked to nuclear power for supplying the required energy. Nuclear reactions a very efficient and the produced energy can produce hydrogen by electrolysis or through a thermo-chemical reaction. As one of ordinary skill in the art will appreciate, using nuclear power suffers the serious drawback of producing nuclear waste.

PCT Patent Application Publication No. WO2010131086 to Osman, U.S. Patent Application No. 2012/0222954 to Lothring, U.S. Pat. No. 4,936,061 to Meyer, U.S. Pat. No. 6,126,794 to Chambers, European Patent Application Publication No. EP0103656 to Meyer, Russian Patent No. RU2496917 to Leonidovich, U.S. Patent Application Publication No. 2007/0205111 to Bayliss, U.S. Patent Application Publication No. 2012/0152197 to Inskeep, U.S. Patent Application Publication No. 2009/0166218 to Darik, U.S. Patent Application Publication No. 2009/0224545 to Davidson, PCT Patent Application Publication No. WO2010/059751, and PCT Patent Application Publication No. WO2010/132973 to Partnou discuss methods of decomposing water into hydrogen and oxygen that do not function as well as the apparatus and processes disclosed herein.

Therefore, what is clearly needed is an apparatus, system, and process for generating hydrogen that is more efficient than electrolysis, and that is cleaner than using methane or nuclear power. This disclosure describes an apparatus that uses electro-magnetic frequency resonance to decompose water into hydrogen and oxygen. The contemplated process weakens the water molecules to either separate them into their constituent parts or to enhance traditional electrolysis.

### SUMMARY OF THE INVENTION

It is one aspect of some embodiments of the present invention to provide an apparatus and method for producing hydrogen using a cell tower comprising a plurality of plates submerged in water. The plates vibrate at a specific resonance frequency to decompose the water into hydrogen and oxygen. The plurality of spaced plates of the cell tower are associated with a circuit that produces an oscillating signal that vibrates plates. The plates vibrate at a frequency at or near the resonance frequency of water molecules. In some instances, the plates generate sufficient energy to decompose water molecules into hydrogen and oxygen. In other modes of operation, electrical charge present in the water surrounding the cell tower separates the resonating water molecules with electrolysis using energy less than it would take to decompose standing water.

The contemplated apparatus generates the required vibrational energy with radio waves transmitted through the plates to modify the atomic bonds of the surrounding water molecules to alter their electrical and magnetic behavior. The generated frequencies reach harmonic and fundamental octaves and modify chemical bonds that bind the water's hydrogen and oxygen atoms. The vibrational energy also modifies the liberated hydrogen atoms by reassigning electrons to a more stable orbit. That is, the apparatus ionizes liberated atoms that gain or lose electrons during decomposition to charge them either positively (cation) or negatively (anion). This is beneficial because it prevents recombination of the recently separated components into H₂O. This process takes place in atoms of one, two, or three electrons the last level of energy atoms combine with five, six, seven electrons in its final orbit. The apparatus modifies the chemical, ionic, covalent, metallic, and hydrogen bond with both, power loads on bridge links and electrostatic charges in chlorides, which are formed by solvation bonds. One of ordinary skill in the art will appreciate “solvation” refers to the interaction of cations and anions in water, in this case the recently separated hydrogen and oxygen in the remaining water.

It is a related aspect of some embodiments of the present invention to provide an apparatus that decomposes water into its constituent parts that does not rely primarily on electrolysis. That is, the contemplated apparatus relies on heterolysis or heterolytic fission driven by electro-magnetic resonance to cleave the oxygen/hydrogen bond wherein both electrons involved in the original bond remain with one of the fragmented atoms. The apparatus of other embodiments relies on homolytic fission to disassociate water molecules wherein each of the fragmented atoms retains one of the originally bonded electrons. During homolytic fission of a neutral molecule with an even number of electrons, two free radicals will be generated. One embodiment produces electro-magnetic resonance energy that makes chemical and structural changes in water molecules and its atoms. The cell tower affects the three vibrational modes of the water molecule which are: symmetrical stretching, asymmetrical stretching and scissoring (bending). The first two modes affect the length of the hydrogen to oxygen atom bonds (1.1 Å approx.), and the latter affects the angle between the hydrogen atoms (104.5 deg.). Vibrational modifications produced by induced frequency bends the hydrogen and oxygen bonds past their preferred 104.5-degree configuration, which separates the hydrogen atom. The electric current found in the water surrounding the cell tower changes the positive hydrogen atoms into negative atoms and, because the hydrogen and oxygen atoms are both negatively charged, they repel and do not reform H₂O.

The separation vibration described herein is reached by the frequency at a low voltage, therefore the contemplated apparatus requires low energy input. Thus, it is another aspect of embodiments of the present invention to provide a hydrogen-producing apparatus and related process capable of efficiently producing large amounts of usable energy with relatively inexpensive electromagnetic frequency waves. The efficiency of one embodiment of the present invention is about 90%. In contrast, efficiency associated with common steam-generated power plant is about 80-90%, and electrolysis has a power generation efficiency of about 70%. In one embodiment, a portion of the produced hydrogen is fed to a generator that powers an electrical control unit that produces the electromagnetic resonance needed to vibrate the plurality of plates. Accordingly, the contemplated apparatus uses its own generated hydrogen to maintain further hydrogen production. The only “fuel” needed is the water, which is continuously added to a tank that may also house the cell tower. A relatively small battery may be employed to initiate hydrogen production, but thereafter energy is primarily taken from the produced hydrogen. Accordingly, pollutants, such as greenhouse gases and nuclear waste, are not produced.

It is still yet another aspect of some embodiments of the present invention to provide a hydrogen-producing apparatus scalable in size. More specifically, the apparatus, which is described below, can be made small enough to be accommodated within a common automobile. In this application of the contemplated invention, water carried by the automobile is the fuel that drives the hydrogen-producing apparatus, wherein the produced hydrogen is used to feed fuel cells or in a hydrogen combustion engine. The exhaust produced by the automobile is water vapor. Because the hydrogen-producing apparatus quickly generates on-demand hydrogen when the plates are vibrated, the majority of the produced hydrogen is used for vehicle propulsion and to power the apparatus to generate additional hydrogen. Accordingly, there is little need to store excess hydrogen, which can be dangerous. As one of ordinary skill in the art will appreciate, the apparatus and related processes described herein may also be made larger. For example, if there is a water source available, the contemplated invention could be used in a large power-producing facility similar to a coal-fired power plant, but much cleaner.

It is still yet another aspect of some embodiments of the present invention to provide an apparatus for producing clean water. More specifically, hydrogen and oxygen produced by the apparatus may be re-combined to produce energy, wherein the byproduct is water vapor. The water vapor can be collected and condensed into clean water. In one application, the contemplated apparatus is used in a desalinization plant that draws in seawater and produces energy, fresh water, and sea salt.

Thus, it is one aspect of embodiments of the present invention to provide a system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; and wherein the generated hydrogen is collected in the hydrogen tank.

It is yet another aspect of embodiments of the present invention to provide a system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; and a power source interconnected to the electrical control wires.

It is still yet another aspect of embodiments of the present invention to provide a method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; and transferring hydrogen items to a storage tank.

Further aspects of the present invention are provided in the following embodiments:

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the power source comprises a battery used to initiate hydrogen production, and a generator that uses a portion the generated hydrogen to generate electricity to support continued hydrogen production.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the first closing plate includes a aperture that allows water to enter the electro-magnetic resonance generation device, and wherein the second closing plate includes a aperture.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the body portion includes a plurality of apertures configured to allow fluid to pass through the electro-magnetic resonance generation device.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the plurality of fasteners comprise a plurality of outer fasteners that directly interconnect the first closing plate to the second closing plate, and plurality of inner fasteners that interconnect the first closing plate, the plurality of inner fasteners being positioned within corresponding apertures in the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area, and the plurality of inner fasteners being positioned within corresponding apertures in the plurality of body portions.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; wherein the plurality of negative resonance plates comprise four plates that vibrate at a frequency of between about 27,000 to about 28,0000 MHz; wherein the plurality of positive resonance plates comprise three plates that vibrate at a frequency of between about 26,000 to about 27,0000 MHz; and wherein a plurality of neutral resonance plates comprise two plates that vibrate at a frequency of between about 28,0000 MHz.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; and wherein the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; wherein the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device; and wherein the apertures are octagonal in shape.

A system for producing hydrogen, comprising: a fluid receptacle; a water source associated with the fluid receptacle; a hydrogen storage tank associated with the fluid receptacle; an electro-magnetic resonance generation device, comprising: a first closing plate; a second closing plate; a plurality of fasteners interconnecting the first closing plate to the second closing plate; a plurality of negative resonance plates positioned between the first closing plate and the second closing plate; a plurality of negative polarization plates positioned between the first closing plate and the second closing plate; a plurality of positive resonance plates positioned between the first closing plate and the second closing plate; a plurality of positive polarization plates positioned between the first closing plate and the second closing plate; a plurality of neutral resonance plates positioned between the first closing plate and the second closing plate; a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control unit; wherein the electrical control unit directs the electro-magnetic resonance generation device to vibrate at a predetermined frequency, and wherein the predetermined frequency decomposes the water surrounding the electro-magnetic resonance generation device into hydrogen and oxygen; wherein the generated hydrogen is collected in the hydrogen tank; wherein the power source comprises a battery used to initiate hydrogen production, and a generator that uses a portion the generated hydrogen to generate electricity to support continued hydrogen production; wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires; wherein the first closing plate includes an aperture that allows water to enter the electro-magnetic resonance generation device, and wherein the second closing plate includes a aperture; wherein the body portion includes a plurality of apertures configured to allow fluid to pass through the electro-magnetic resonance generation device; wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area; wherein the plurality of fasteners comprise a plurality of outer fasteners that directly interconnect the first closing plate to the second closing plate, and plurality of inner fasteners that interconnect the first closing plate, the plurality of inner fasteners being positioned within corresponding apertures in the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area, and the plurality of inner fasteners being positioned within corresponding apertures in the plurality of body portions; wherein the plurality of negative resonance plates comprise four plates that vibrate at a frequency of between about 27,000 to about 28,0000 MHz; wherein the plurality of positive resonance plates comprise three plates that vibrate at a frequency of between about 26,000 to about 27,0000 MHz; and wherein the plurality of neutral resonance plates comprise two plates that vibrate at a frequency of between about 28,0000 MHz; wherein the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device; and wherein the apertures are octagonal in shape.

A system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control wires; and wherein the power source comprises a battery used to initiate hydrogen production, and a generator that uses a portion the generated hydrogen to generate electricity to support continued hydrogen production.

A system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control wires; and wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires.

A system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control wires; and wherein the first closing plate includes an aperture that allows water to enter the electro-magnetic resonance generation device, and wherein the second closing plate includes a aperture.

A system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control wires; and wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area.

A system for producing hydrogen, comprising: a fluid receptacle; a water source associated with the fluid receptacle; a hydrogen storage tank associated with the fluid receptacle; an electro-magnetic resonance generation device submerged in the fluid receptacle, comprising: a first closing plate; a second closing plate; a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate; a plurality of positive polarization induction wires interconnected to the plurality of positive polarization plates; a plurality of negative polarization induction wires interconnected to the plurality of negative polarization plates; a plurality of positive resonance induction wires interconnected to the plurality of positive polarization plates; a plurality of negative resonance induction wires interconnected to the plurality of negative polarization plates; a plurality of neutral wires interconnected to the plurality of neutral plates; a plurality of body portions position between each of the polarization and resonance plates; an electrical control unit interconnected to the positive polarization wires, the positive resonance wires, negative polarization wires, negative resonance wires, and the neutral wires; a power source interconnected to the electrical control wire; wherein the power source comprises a battery used to initiate hydrogen production, and a generator that uses a portion the generated hydrogen to generate electricity to support continued hydrogen production; wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires; wherein the first closing plate includes an aperture that allows water to enter the electro-magnetic resonance generation device, and wherein the second closing plate includes a aperture; and wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area.

A method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; transferring hydrogen items to a storage tank; and wherein the oxygen atoms are stored in a second storage tank.

A method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; transferring hydrogen items to a storage tank; and further comprising directing the hydrogen items to a generator that uses the hydrogen to produce electricity that is directed to the cell tower.

A method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; transferring hydrogen items to a storage tank; and wherein the frequency induction is generated by vibrational energy emanating from the cell tower, the vibrational energy being controlled by an electronic control unit associated by the cell tower.

A method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; transferring hydrogen items to a storage tank; and wherein the water is continuously direct to the cell tower, and wherein hydrogen production is on-demand.

A method of producing hydrogen, comprising: introducing water to a reservoir; feeding water to a cell tower; using the cell tower to initiate atomic polarization of the water by magnetic induction; using the cell tower to separate water molecules into hydrogen atoms and oxygen atoms by frequency induction; separating the hydrogen atoms and the oxygen atoms with a magnetic field generated by the cell tower; transferring hydrogen items to a storage tank; wherein the oxygen atoms are stored in a second storage tank; further comprising directing the hydrogen items to a generator that uses the hydrogen to produce electricity that is directed to the cell tower; wherein the frequency induction is generated by vibrational energy emanating from the cell tower, the vibrational energy being controlled by an electronic control unit associated by the cell tower; and wherein the water is continuously direct to the cell tower, and wherein hydrogen production is on-demand.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a schematic of one embodiment of the present invention;

FIG. 2 is a simplified schematic of one embodiment of the present invention;

FIG. 3 is a flow diagram of a process of one embodiment of the present invention;

FIG. 4 is a perspective view of a cell tower of one embodiment of the present invention;

FIG. 5 is an elevation view of the cell tower shown in FIG. 4;

FIG. 6 is a top plan view of the cell tower shown in FIG. 5;

FIG. 7 is a cross-sectional view of FIG. 4;

FIG. 8A is a perspective view of a body portion of the cell tower;

FIG. 8B is a front elevation view of the body portion;

FIG. 8C is a cross-sectional view of FIG. 8B;

FIG. 8D is a detailed view of FIG. 8C;

FIG. 8E is a side elevation view of the body portion;

FIG. 8F is a detailed view of FIG. 8E;

FIG. 8G is a detailed view of FIG. 8E;

FIG. 9A is a perspective view of a resonance plate of one embodiment of the present invention;

FIG. 9B is a top elevation view of the resonating plate;

FIG. 9C is a detailed view of FIG. 9B;

FIG. 10A is a perspective view of a lid used by the cell tower of one embodiment of the present invention;

FIG. 10B is a front elevation view of FIG. 10A;

FIG. 10C is a side elevation view of FIG. 10A;

FIG. 10D is a cross-sectional view of FIG. 10B;

FIG. 11 is a perspective view of a cell tower of another embodiment of the present invention;

FIG. 12 is a side elevation view of FIG. 11;

FIG. 13 is a top plan view of FIG. 11;

FIG. 14 is a perspective view of a cell tower of another embodiment of the present invention;

FIG. 15 is a front elevation view of FIG. 14;

FIG. 16 is a side elevation view of FIG. 14;

FIG. 17 is a top plan view of FIG. 14;

FIG. 18 is a circuit diagram of a module for positive polarization employed by some embodiments of the present invention;

FIG. 19 is a circuit diagram of a module for negative polarization employed by another embodiment of the present invention;

FIG. 20 is a circuit diagram of a module for negative polarization employed by another embodiment of the present invention;

FIG. 21 is a circuit diagram of a module for positive polarization employed by another embodiment of the present invention;

FIG. 22 is a circuit diagram of n oscillation coupling module employed by some embodiments of the present invention;

FIG. 23 is a circuit diagram of a voltage regulator employed by some embodiments of the present invention;

FIG. 24 is a circuit diagram of an amplifier employed by some embodiments of the present invention;

FIG. 25 is a circuit diagram of a RF generator and amplifier employed by some embodiments of the present invention;

FIG. 26 is a circuit diagram of an electronic control unit;

FIG. 27 is a circuit diagram of a negative polarization pulse module;

FIG. 28 is a circuit diagram of a frequency recorder; and

FIG. 29 is a circuit diagram showing microphone connections.

To assist in the understanding of one embodiment of the present invention the following list of components and associated numbering found in the drawings is provided herein:

| # | Component |
|---|---|
| 2 | Hydrogen producing apparatus |
| 6 | Water inlet |
| 8 | Coil |
| 10 | Water storage tank |
| 18 | Cell tower |
| 22 | Diode rectification bridge array |
| 26 | AC/DC inverter |
| 30 | Electronic control unit |
| 34 | Battery pack |
| 36 | Plate |
| 38 | Hydrogen pressure vessel |
| 39 | Oxygen pressure vessel |
| 42 | Water source |
| 44 | Water return line |
| 45 | Water purge |
| 46 | Generator |
| 80 | Upper lid |
| 84 | Lower lid |
| 88 | Body portions |
| 92 | Tab |
| 96 | Rod |
| 100 | Negative frequency lead |
| 104 | Negative polarization lead |
| 108 | Positive polarization lead |
| 112 | Positive frequency lead |
| 116 | Neutral lead |
| 120 | Opening |
| 124 | Fasteners |
| 128 | O-rings |
| 132 | Outer edge |
| 136 | Peripheral opening |
| 140 | Outer opening |
| 144 | Center opening |
| 148 | Gap |
| 152 | Outer edge |
| 156 | Aperture |
| 160 | Outer opening |
| 164 | Center opening |
| 172 | Periphery holes |
| 176 | Inner holes |
| 180 | Cavity |
| 184 | Center hole |
| 188 | Lead holes |
| 192 | Negative resonance plate |
| 196 | Neutral plate |
| 200 | Positive resonance plate |
| 204 | Positive terminal |
| 208 | Negative terminal |

It should be understood the drawings are not necessarily to scale. In certain instances, details not necessary for an understanding of the invention or that render other details difficult to perceive may have been omitted. It should be understood, of course, that the invention is not necessarily limited to the particular embodiments illustrated herein.

### DETAILED DESCRIPTION

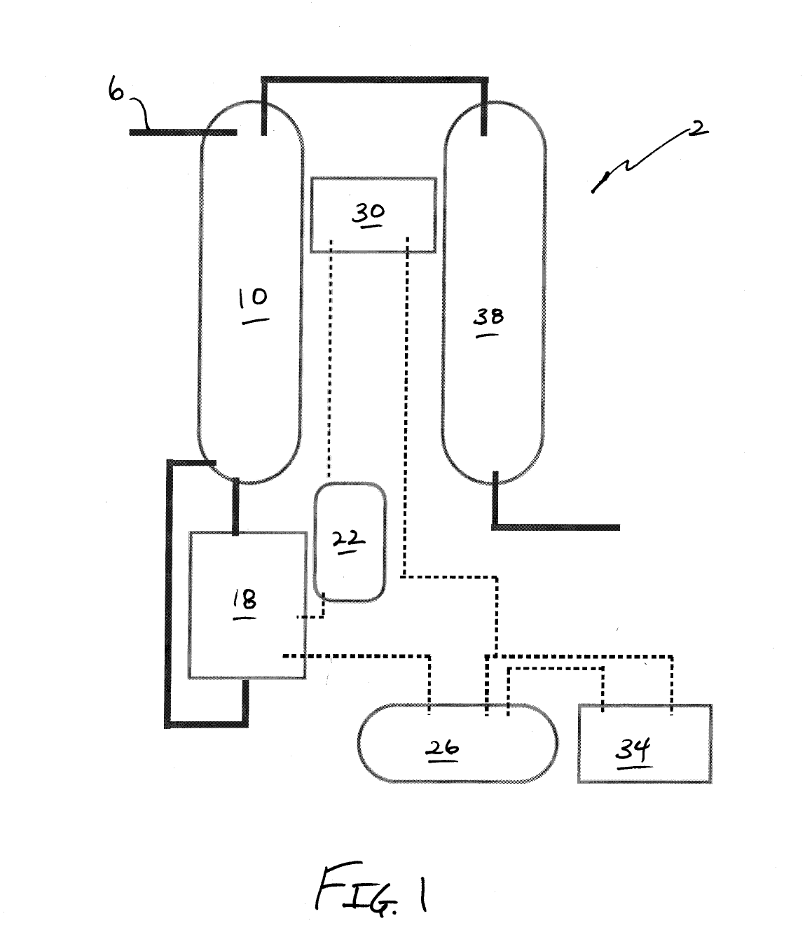

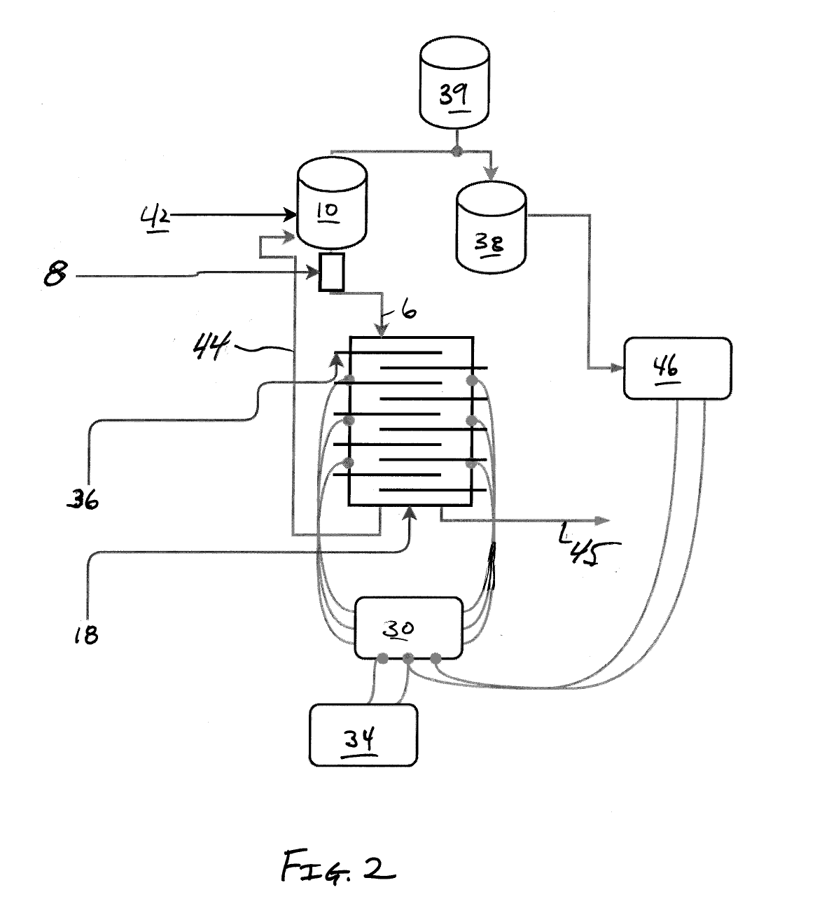

FIGS. 1 and 2 are schematics of a hydrogen-producing apparatus 2 of one embodiment of the present invention. FIG. 1 shows a water inlet 6 that feeds water into a water storage tank 10. A coil 8 may be provided. Water taken from the water storage tank 10 is fed to a cell tower 18. The cell tower 18 is in electric communication with a diode rectification bridge array 22 and an AC/DC inverter 26. The AC/DC inverter 26 sends energy to an oscillation coupling module (see, FIG. 22) that generates an AC frequency. The generated frequency is transferred to the diode bridge array 22 that rectifies and converts to the frequency to DC. The DC frequency is then transferred to the cell tower 18 by a distribution module. The AC/DC inverter 26 and the diode rectification bridge array 22 are coupled electronically to an electronic control unit 30 energized by a battery pack 34. The battery pack 34 of one embodiment comprises two 12 V gel type 90 Ah batteries connected to the cell tower 18 and to the AC/DC inverter 26. The electronic control unit 30 directs the desired pulsations to the cell tower 18 which are transferred to plates 36. The plates generate ultra-high frequency (UHF) vibrations that weaken or split the water molecule bonds by bending them past their natural angle of movement. The UHF also polarizes the liberated oxygen and hydrogen atoms to prevent molecule reassembly. The apparatus also includes a hydrogen pressure vessel 38 coupled with the water storage tank 10. In operation, produced hydrogen bubbles through the water storage tank 10 into the hydrogen pressure vessel 30.

FIG. 2 is a simplified schematic showing one embodiment of the present invention. Here, the cell tower 18 is in communication with a water storage tank 10 that receives water from a water source 42, e.g., a reservoir, a lake, the sea, etc. In one embodiment, the cell tower provides a closed, or semi-closed, volume that receives water through at least one opening. When activated, the battery pack 34 energizes the electronic control unit 30 and the other electrical components in electrical communication with the cell tower 18. The electrical control unit 30 imparts vibrational energy onto plates 36 of the cell tower 10, which will be described in further detail below. The electrical-resonant energy produced by the plates 36 excites the water molecules and splits them into their constituent parts. The ionized hydrogen and oxygen are drawn to positive and negative leads of the cell tower, and are exhausted into atmosphere (in the case of oxygen), or are directed to the hydrogen pressure vessel 38 (the case of hydrogen.) In some embodiments, produced oxygen gas is stored in an oxygen pressure vessel 40. The polarized gasses may be dissolved in cell tower water and fed to the water storage tank 10 via a water return line 44; wherein the polarized gases bubble through the water storage tank 10 and are directed to their respective pressure vessels. Excess water exiting the cell tower can be purged 45 if necessary. Portion of the stored hydrogen is taken from the hydrogen pressure vessel 38 and directed to a hydrogen powered generator 46 that produces electricity to power the electronic control unit 30 and related components.

FIG. 3 is a schematic representing the process employed by some embodiments of the present invention. Water from the reservoir is fed to the cell tower 50. After the cell tower is energized, the water is atomically polarized by magnetic induction 54. Next, frequency induction is initiated wherein the water inside the cell tower is energized, which weakens or separates the hydrogen/oxygen bonds of the water molecules 62. Ionized hydrogen and oxygen atoms are then routed by a magnetic field to negative or positive terminals of the cell tower, which separates the decomposed hydrogen and oxygen and prevents them from recombining 66. The liberated hydrogen is then forwarded to the water storage tank 10 and into the hydrogen pressure vessel 38. The produced gas may be filtered if desired 74. Accordingly, the apparatus provides stable and harmonic frequency that separates out chemical compounds from water, and the ionic and covalent hydrogen-oxygen bonds, which allows the atomic-molecular association and dissociation of water.

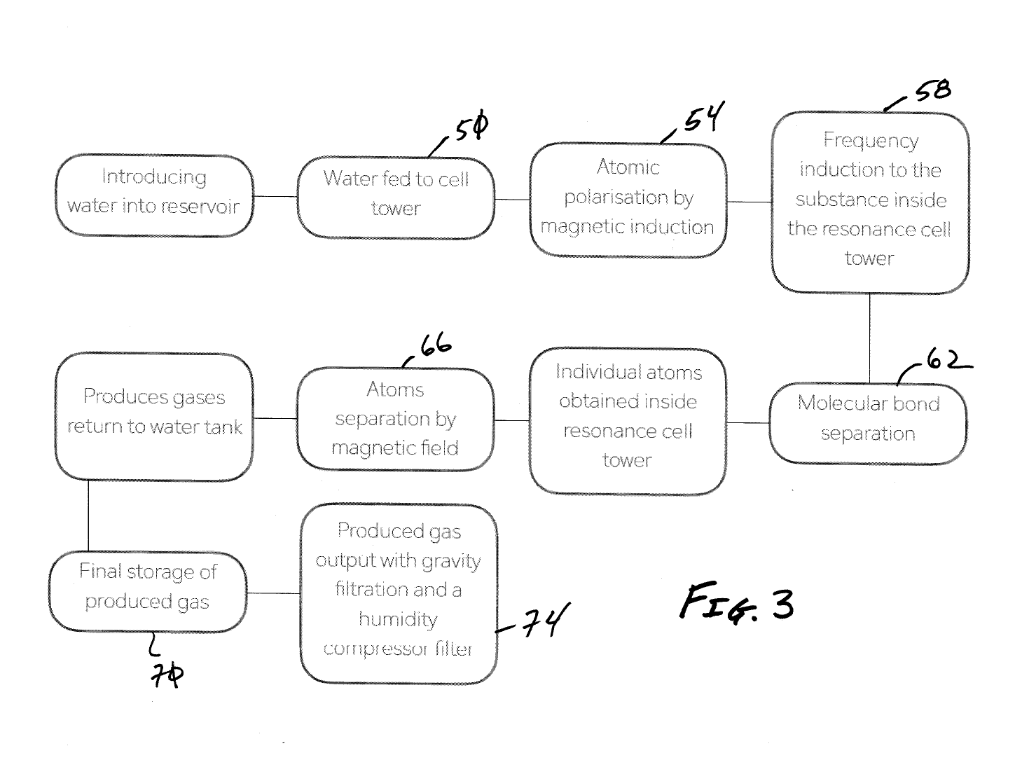

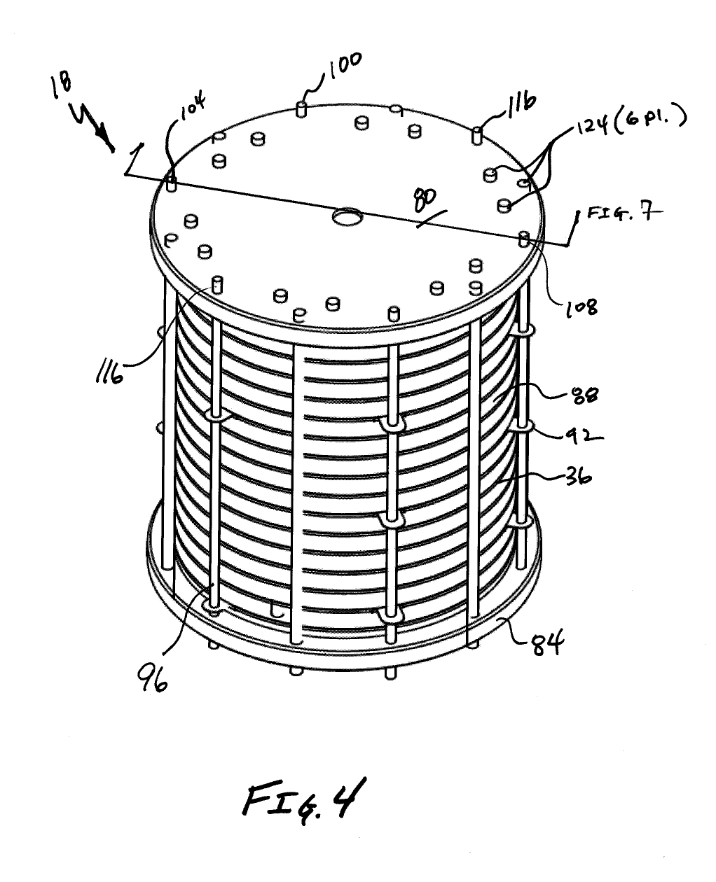

FIGS. 4-10 show the cell tower 18 of one embodiment of the present invention. The cell tower 18 is defined by an upper lid 80 spaced from a lower lid 84. A plurality of plates 36 separated by body portions 88 are positioned between the upper lid 80 and the lower lid 84. Each plate 36 has a tab 92 extending therefrom that interfaces with a rod 96 associated with either a positive lead, a negative lead, or a neutral lead. In some embodiments, however, positive, negative, and neutral leads are interconnected directly to the plates and the rods are omitted. As shown, the cell tower 18 employs a negative frequency lead 100, a negative polarization lead 104, a positive polarization lead 108, and a positive frequency lead 112. Some plates 36 are interconnected to neutral leads 116. Again, some embodiments omit rods wherein the plates interconnected to the electronic control unit by way of negative frequency wires, negative polarization wires, positive polarization wires, positive frequency wires, and neutral wires as shown in FIG. 2.

The upper lid 80 employs at least one opening 120 that allows water to enter the cell tower 18 by way of a connector. The lower lid 84 also employs an opening that allows water to exit the cell tower through a connector. Fasteners 124 extend from the lower lid 84 to the upper lid 80 to create a tight sandwich structure of lids, body portions, o-rings, and plates. Thus, the cell tower 18 can operate at high pressures because the body portions contain the axial pressure being generated as hydrogen is produced. That is, the body portions 88 and o-rings 128 form a casing that prevents gas leakage generated by pressure inside the cell tower.

Resonance vibration inside the cell tower induced by an electric current provides induction to nodes of the chemical, ionic, and covalent bonds. This contemplated system delivers an electric current modified by radio frequency in such a way that it reaches the natural harmonic frequency of the water molecule's three vibrational modes, disassembling the oxygen/hydrogen bonds by induced resonance. In the apparatus's electric system, the resonance frequency is such that it reaches its maximum transfer function, which means given a certain input a maximum output is obtained. Stated differently, if the energy input is at a specific frequency the absorption rate is the maximum possible. This gives place to an instability in the system or a simple rupture in some point of the system. In the case of the link nodes between hydrogen and oxygen, and other structural molecular and atomic bonds without the intervention of the bonds where the ions of the periodic elements have the tendency to complete their outermost energy level with 8 electrons (octet rule), resulting in a very stable form, such as the noble gases being electrochemically stable, in other words its highly difficult that they react to any other element.

This rule applies to the creation of the bonds between atoms, the nature of these bonds will determine the behavior and properties of the molecules. These properties will depend on the type of bond, the number of bonds per atom and the intermolecular forces. There are different types of chemical bonds, all based in the stability of this special electrical configuration of noble gases, with a tendency of having eight electrons on their outermost every level. This electronic octet can be acquired by an atom in different ways, metallic bonding, coordinated bonding, intermolecular bond, intramolecular bonds, and ionic and covalent bonds. Because of solvation, the apparatus of one embodiment does not produce resonance frequency sufficient to reach the octet equilibrium. However, the octet equilibrium between H₂O molecule clusters that form with solutes present in the water stream are broken.

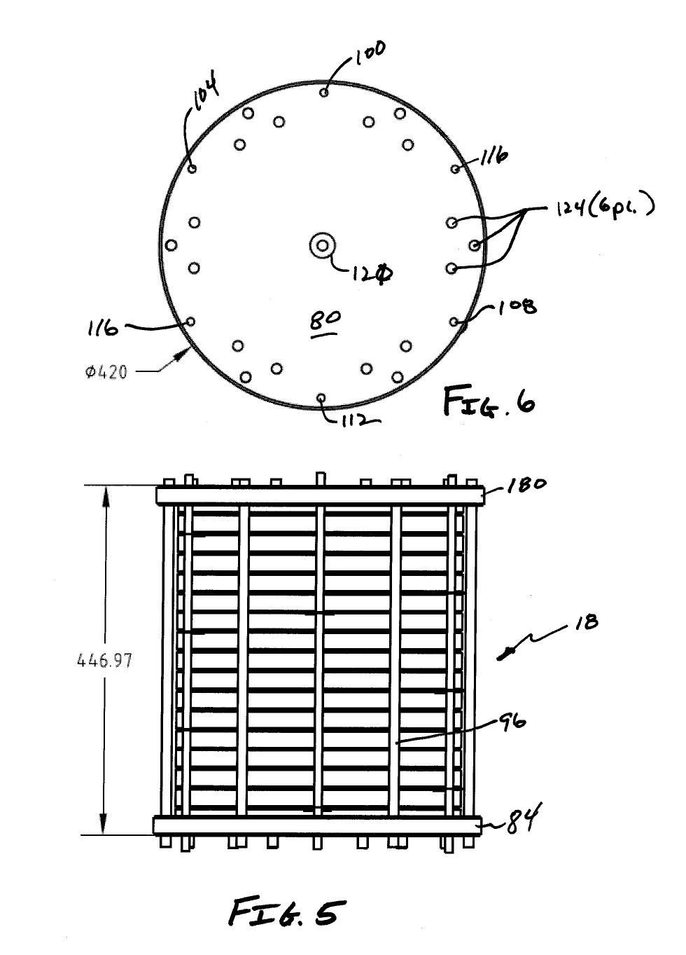

FIG. 7 is a cross-section showing the way the body portions 88 and plates 36 are configured in one embodiment of the present invention. Again, the cell tower 36 includes an opening 120 at its top and bottom that allow water to penetrate the lids. The plates 36 and body portions 88 also include at least one opening that allow for water to pass. The outer portions of the plates are maintained by the body portions, but the internal portions of the plates are spaced from internal portions of the body such that the plates can vibrate. The upper lid in the lower lid include apertures that receive the rods for polarization and frequency generation.

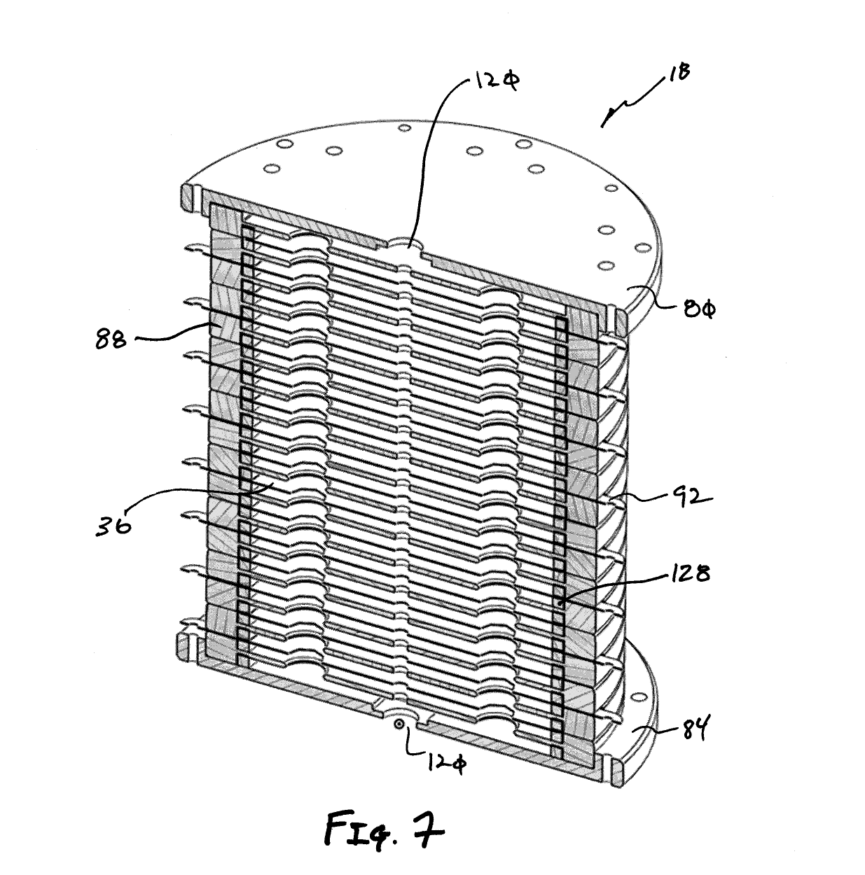

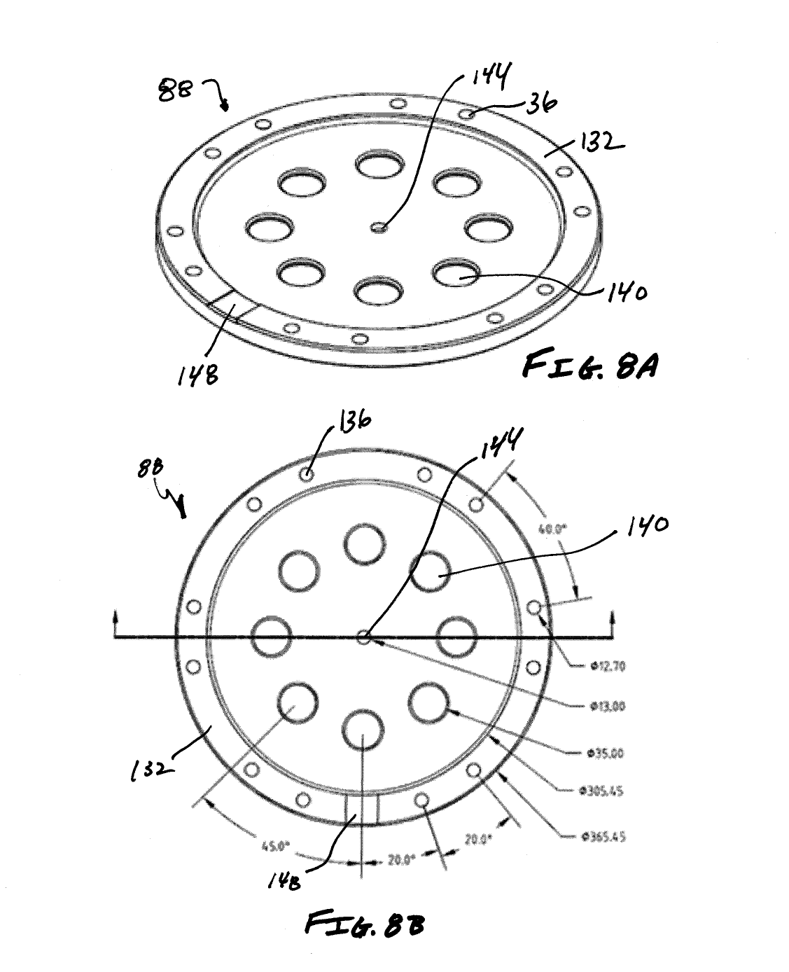

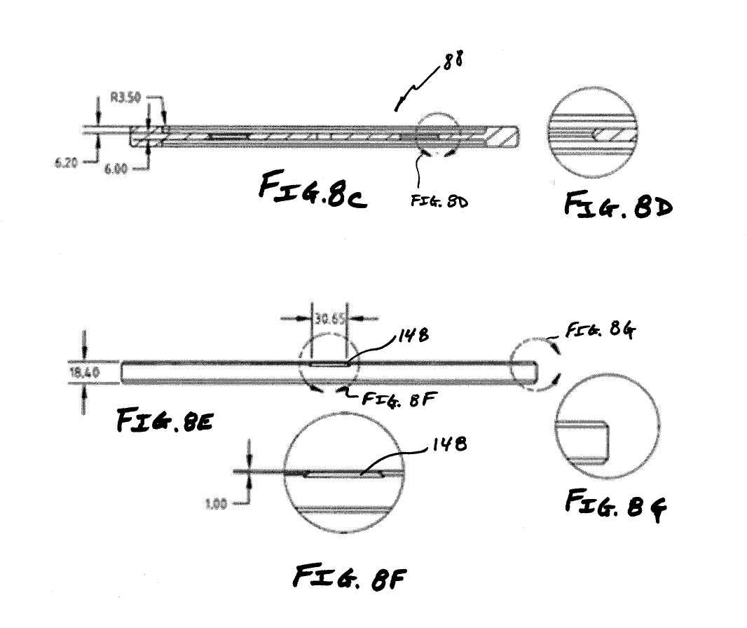

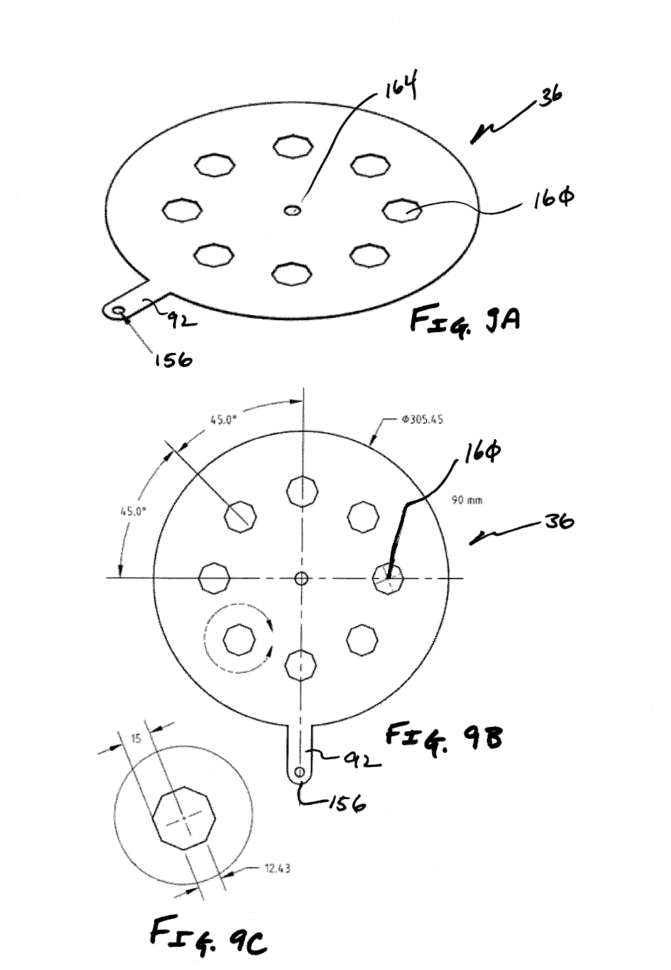

FIGS. 8A-8G show the body portions 88 of one embodiment of the present invention. The body portions 88 are circular having a widened outer edge 132 with a plurality of peripheral openings 136 that receive the rods associated with polarization and frequency leads. The peripheral openings 120 also accommodate the fasteners that extend between the upper lid and the lower lid. The body portions 88 include outer openings 140 and a center opening 144 that allow water to pass through the cell tower and collected gases to escape. The outer edge 132 also comprises a gap 148 which accommodates the tabs of the resonance plates. The body portions can be made of nylon, or any other synthetic polymer.

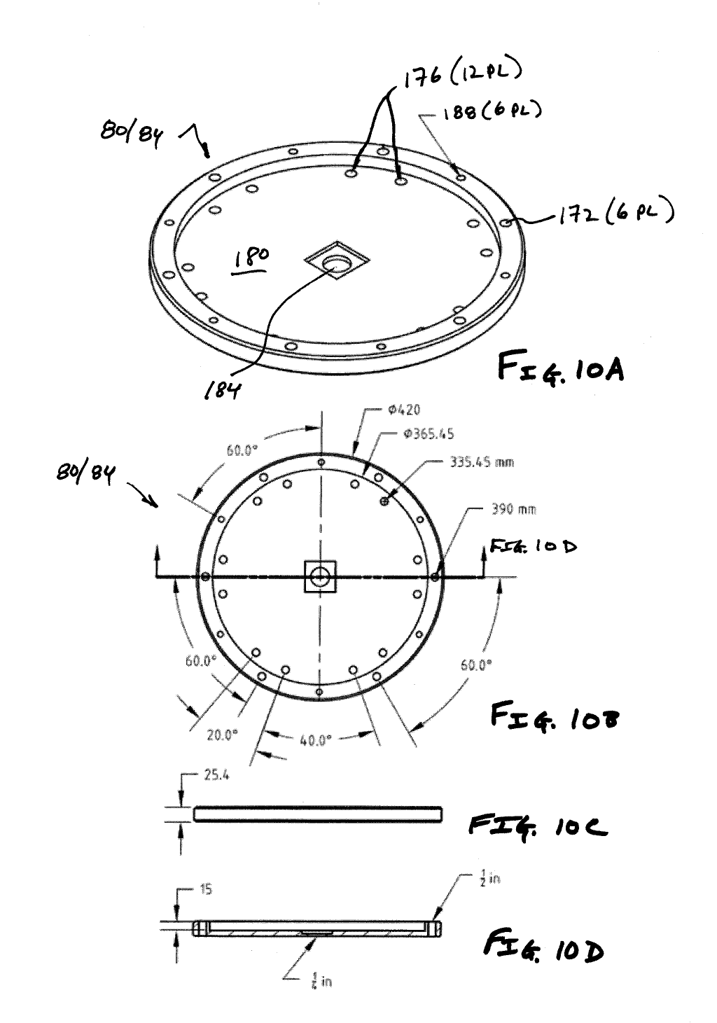

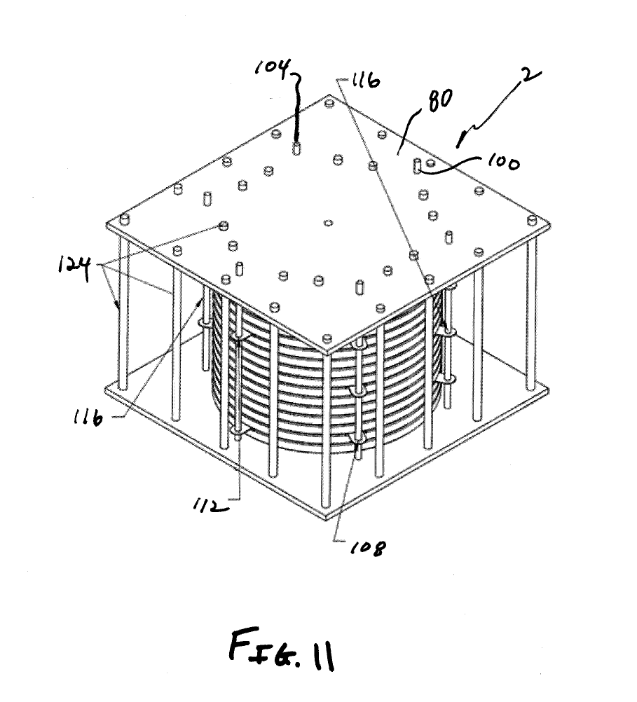

FIGS. 9A-9C show the resonance plates 36 of one embodiment of the present invention that are circular with the aforementioned tab 92 extending from an outer edge 152 thereof. The tab 92 includes an aperture 156 that accommodates rods shown in FIG. 4. The resonance plates 36 also include a plurality of outer openings 160 and a center opening 164. The openings are configured to allow water/gas to flow through the cell tower. The outer openings 160 are also designed to facilitate resonance frequency generation. That is, the outer openings 160 create voids in the resonance plate 36 that affect its dynamic properties, wherein the size and shape of the outer openings 160 will dictate the plate's mass and mass moment of inertia, which will dictate its resonance frequency. The outer openings of this embodiment are octagonal, but those of skill in the art will appreciate that various shapes can be used without departing from the scope of the invention.

The position of the resonance plate 36 in the cell tower array dictates its function, because each plate is in contact with only one current-carrying lead. In one embodiment, there are six possible positions for the plates—neutral, resonance (splitting), and polarization. The neutral plates do not conduct electricity and do not carry energy, but act as tuning forks that resonate with the other set of plates that carry energy and frequency to intensify the desired outcome. Two resonance plates are interconnected to positive and negative leads that carry resonance splitting frequency. The other resonance plates are associated with positive and negative leads carrying polarization inducing frequency which prevent hydrogen and oxygen atoms recombining. The resonance plates can be made of stainless steel.

The cell tower of one embodiment employs sixteen resonance plates configured in the following manner to resonant the water in the cell tower. That is, there are three different frequencies in play—two for positive and negative polarization, one for each, and one for both the positive and negative resonance inducing frequency. These frequencies exist in the system of one embodiment of the present invention as follows:

| Plate | Connected to | Polarity | Frequency |
|---|---|---|---|
| 1 | Diode Bridge 1 | + | 26,065 |
| 2 | UHF Generator | − | 27,445 |
| 3 | UHF Generator | + | 28,045 |
| 4 | UHF Generator | + | 28,045 |
| 5 | Electronic Module 3 | − | 28,045 |
| 6 | UHF Generator | + | 28,045 |
| 7 | Electronic Module 3 | − | 28,045 |
| 8 | Electronic Module 2 | + | 28,045 |
| 9 | Electronic Module 4 | − | 27,445 |
| 10 | Electronic Module 4 | − | 27,445 |
| 11 | Electronic Module 2 | + | 28,045 |
| 12 | Electronic Module 4 | − | 27,445 |
| 13 | Electronic Module 2 | + | 28,045 |
| 14 | Electronic Module 4 | − | 27,445 |
| 15 | Electronic Module 2 | + | 28,045 |
| 16 | Diode Bridge 1 | − | 26,065 |

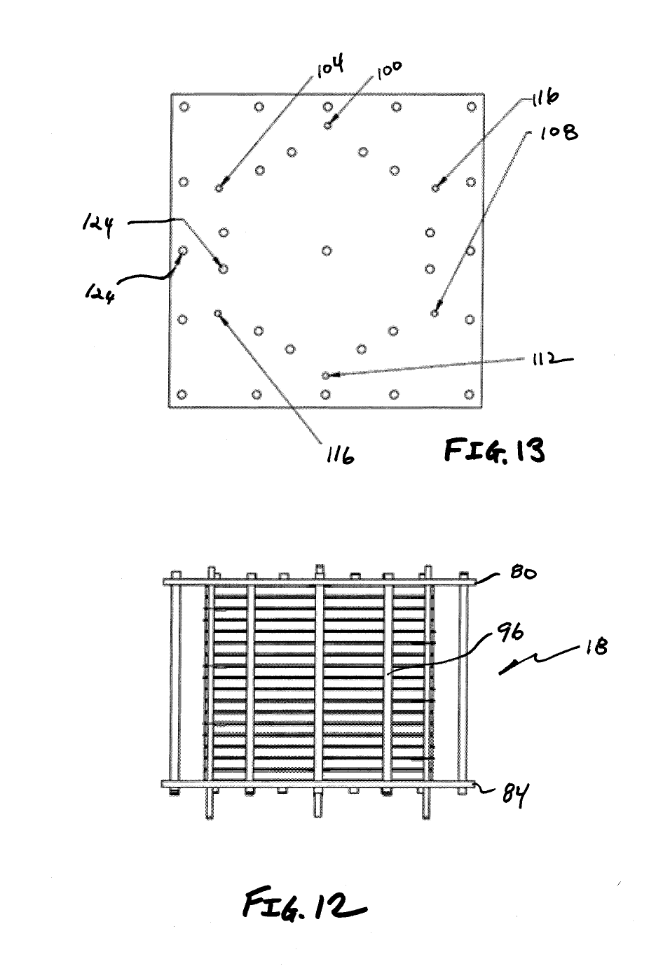

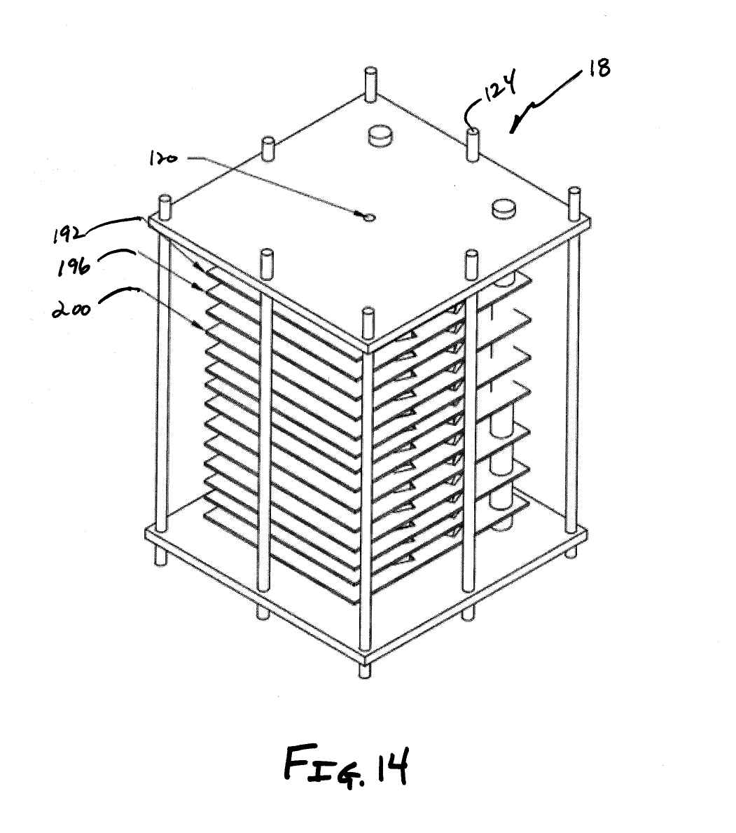

FIGS. 10A-10D show the lids 80/84 of one embodiment of the present invention. The lids are non-conductive and feature a circular array of holes that receive fasteners secure and close the cell tower. The holes are arranged in a triangular fashion wherein periphery holes 172 from the center close the cell tower and the inner holes 176 fasten and secure the body portions. The lids 80/84 also provide a cavity 180 that receives the uppermost and lowermost body portion. Each lid has a center hole 184 that receives a coupling that connects the cell tower to the peripheral components of the apparatus. An array of lead holes 188 receive rods that align each individual plate and assign it its function.

In one embodiment, the upper lid is fitted with 450 mm long bolts with an O-ring centered and fit into a body portion resting inside the lid cavity. A second O-ring is inserted inside the protruding part of the first body portion and a neutral resonance plate is installed in position, wherein the hole in the plate's tab is aligned with the neutral lead. This sub-assembly is repeated as the body portions are stacked onto each other and rotated 60 degrees, aligning the next resonance plate to its respective lead. For every two pairs of conductive plates one must alternate with a neutral plate. The order of one embodiment is as follows: neutral, positive resonance, positive polarization, negative resonance, negative polarization, and neutral. The cell tower is then connected to the water reservoir from the top and bottom lids of the cell, wherein the top opening feeds water to the cell tower and the bottom opening recirculates water and produced gas back to the water storage tank as it doubles as a bubbler to cool the produced gas and allow the natural separation of the gases by different densities.

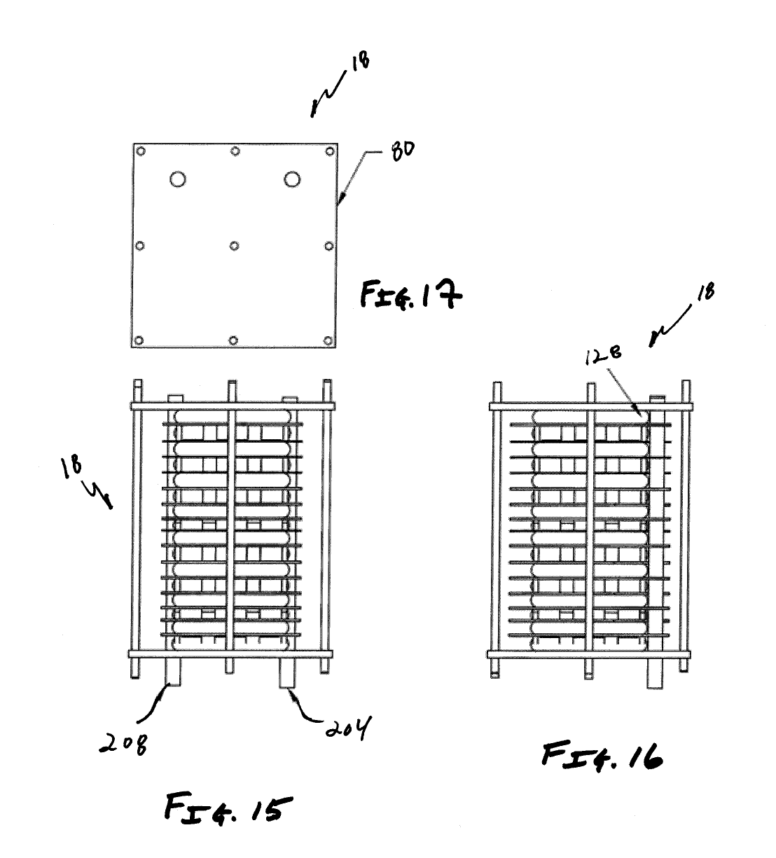

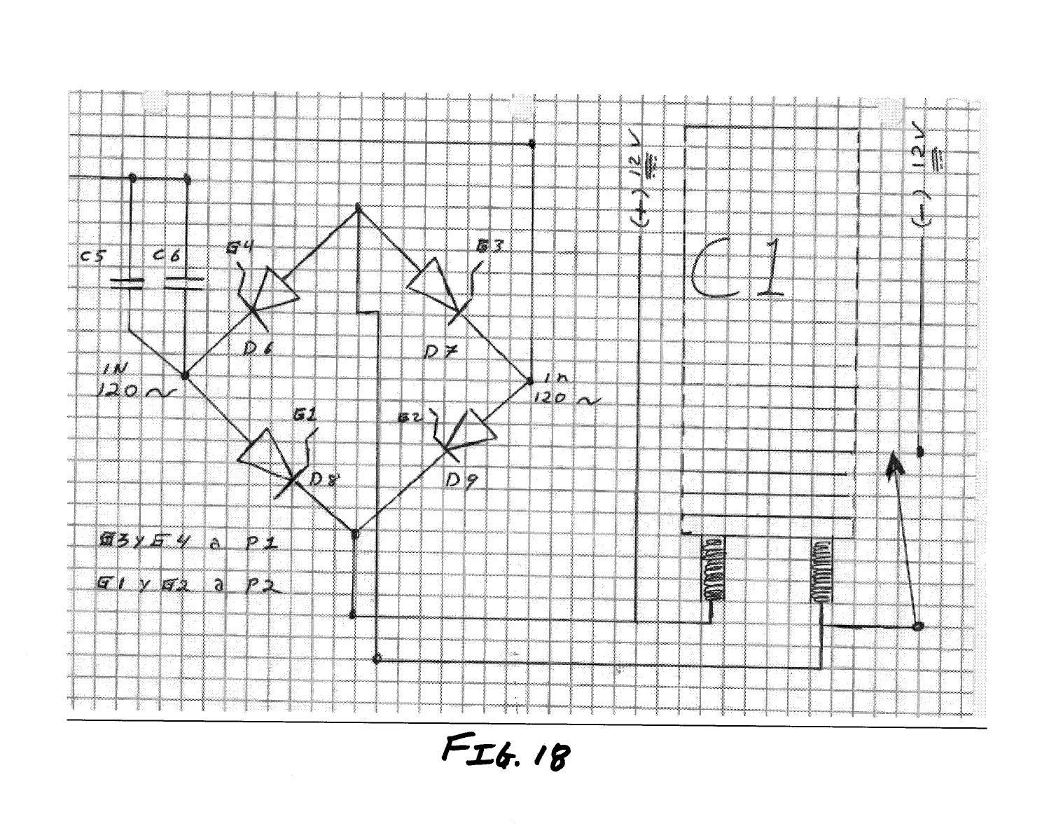

FIGS. 11-13 show another embodiment of the present invention that employs square-shaped lids, the remaining arraignment of the resonance plates, body portions, etc. are the same as the cellular tower described above.

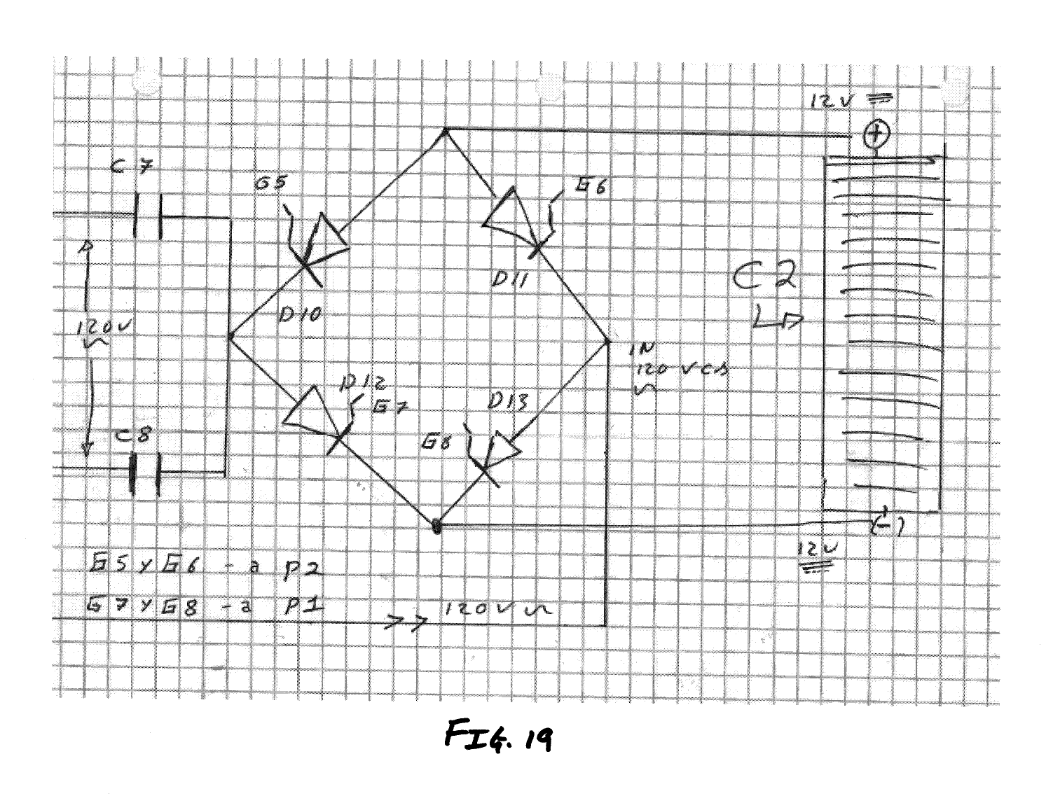

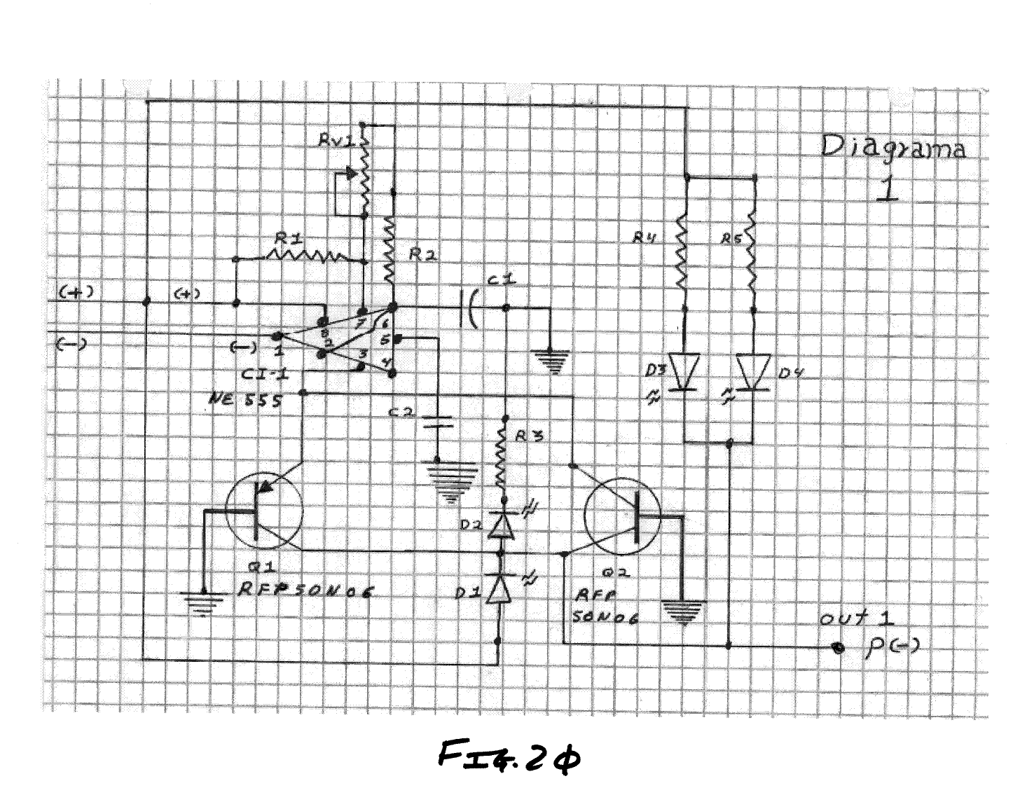

FIGS. 14-17 show another embodiment of the present invention that employs square-shaped lids, the remaining arraignment of the resonance plates, body portions, etc. are the same as the cellular tower described above. The cell tower provided includes negative resonance plates 192, neutral resonance plates 196, and positive resonance plates 200.

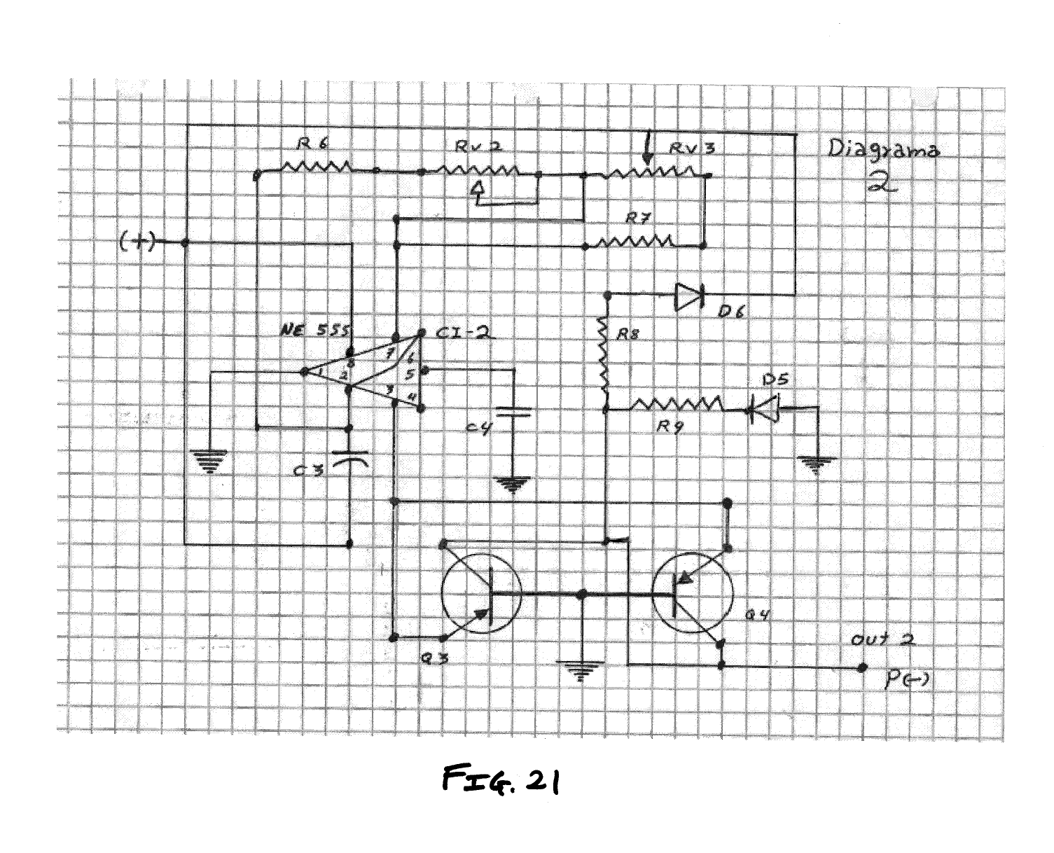

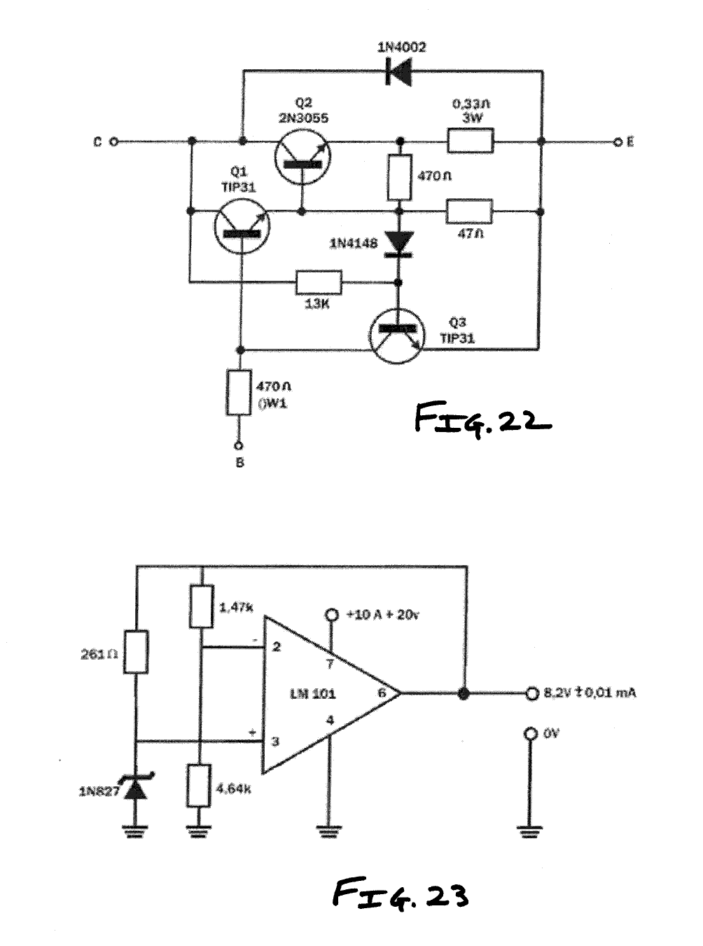

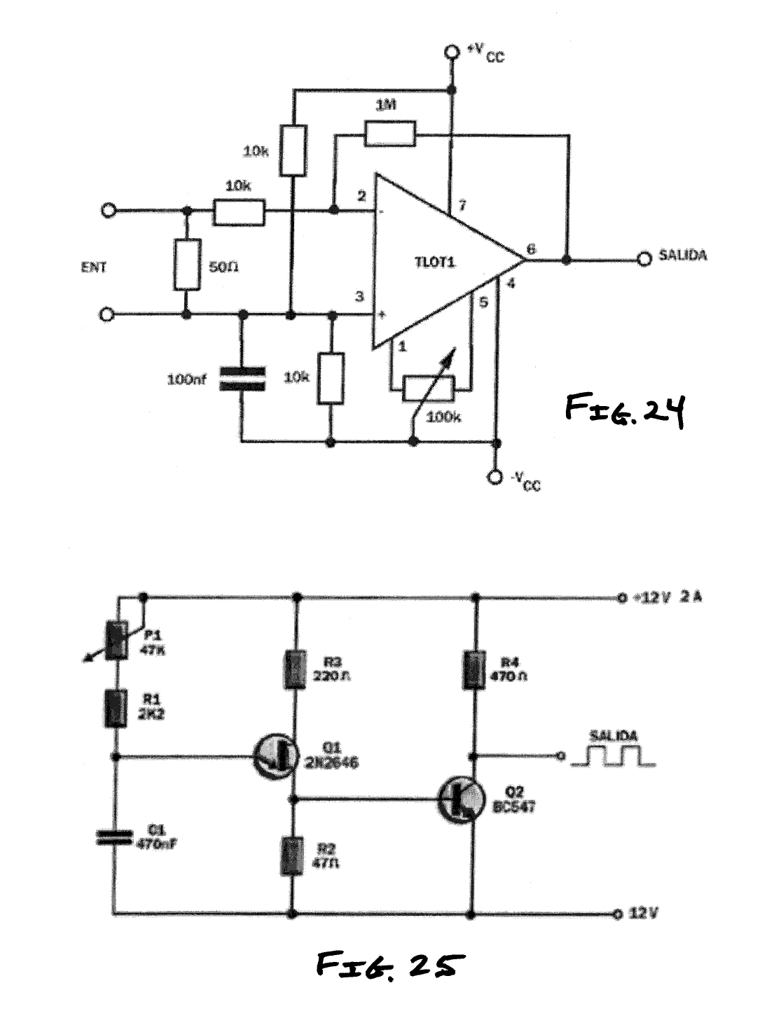

FIGS. 18 and 21 comprise positive polarization pulse modules that feed polarization energy to the positive polarization plates. Similarly, FIGS. 19 and 20 comprise negative polarization pulse modules that feed polarization energy to the negative polarization plates. The positive and negative polarization modules produce auto-adjustable electric pulsation and time period with low voltage in a square wave, which feeds the output transistors as they interact with trigger diodes being fed by the inverter. A sinusoidal wave is, thus, produced and these two signals combine each oscillation period with the energy of the rectifying diode bridge array rendering AC into DC with positive oscillations that carry a 28.045 MHz with are routed to the resonance plates.

FIG. 22 is a circuit diagram of a frequency generator of one embodiment of the present invention.

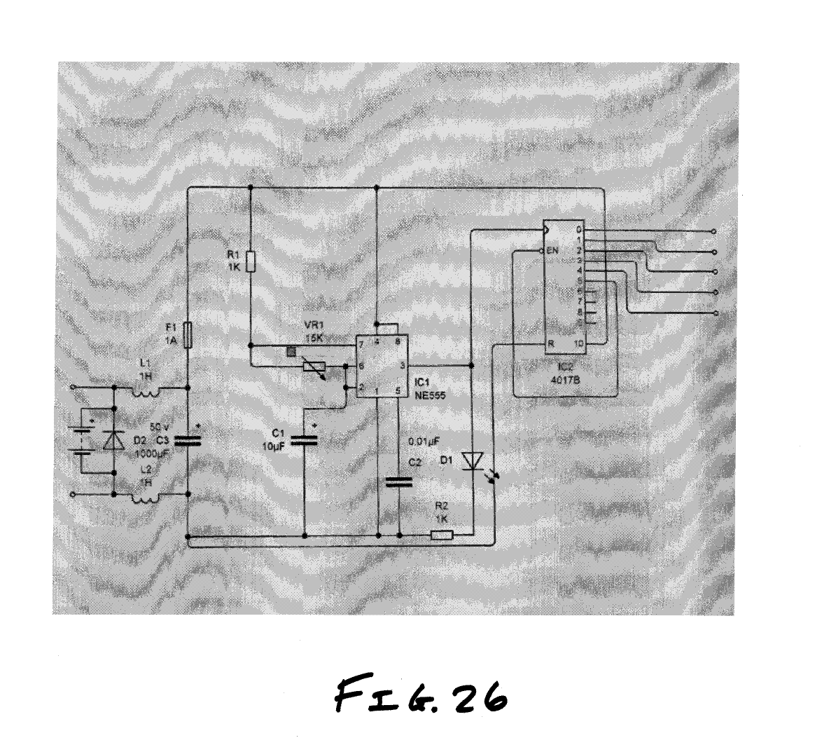

FIG. 23 is a radio frequency wattage amplifier that feeds output transistors connected to a diode bridge that is connected to the positive and negative polarization plates.

FIG. 24 is a pre-amplifier that receives a low RF signal and amplifies it and prevents distortion and a stationary wave. This component feeds the component shown in FIG. 23.

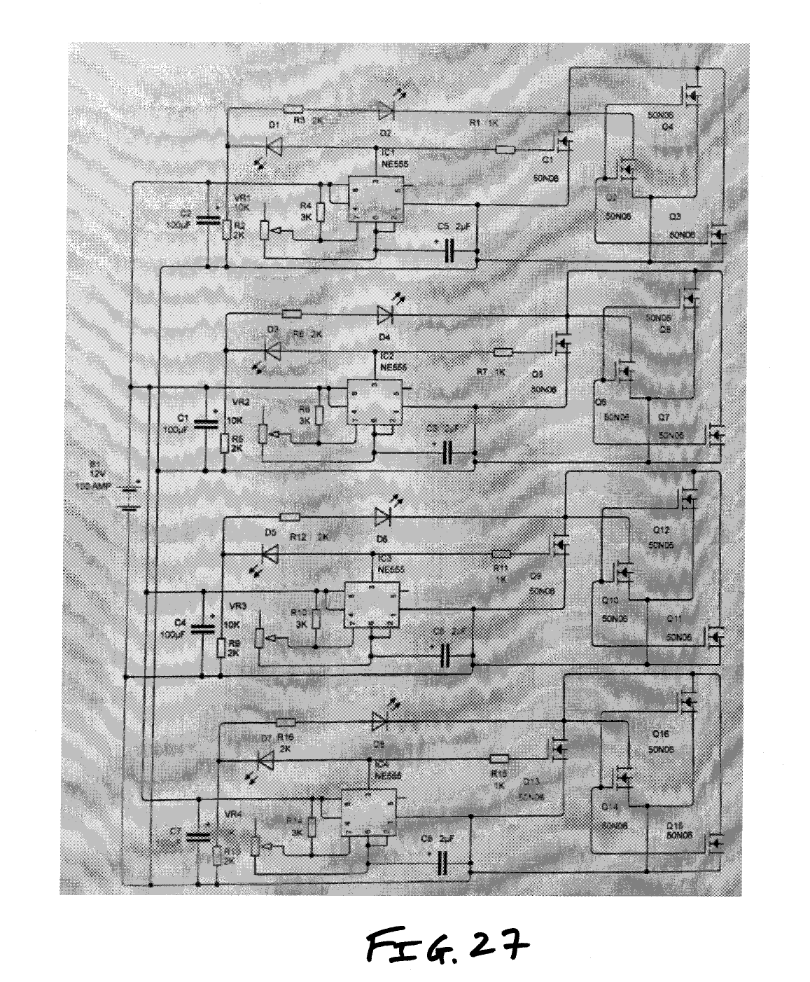

FIG. 25 is a frequency amplifier of one embodiment of the present invention.

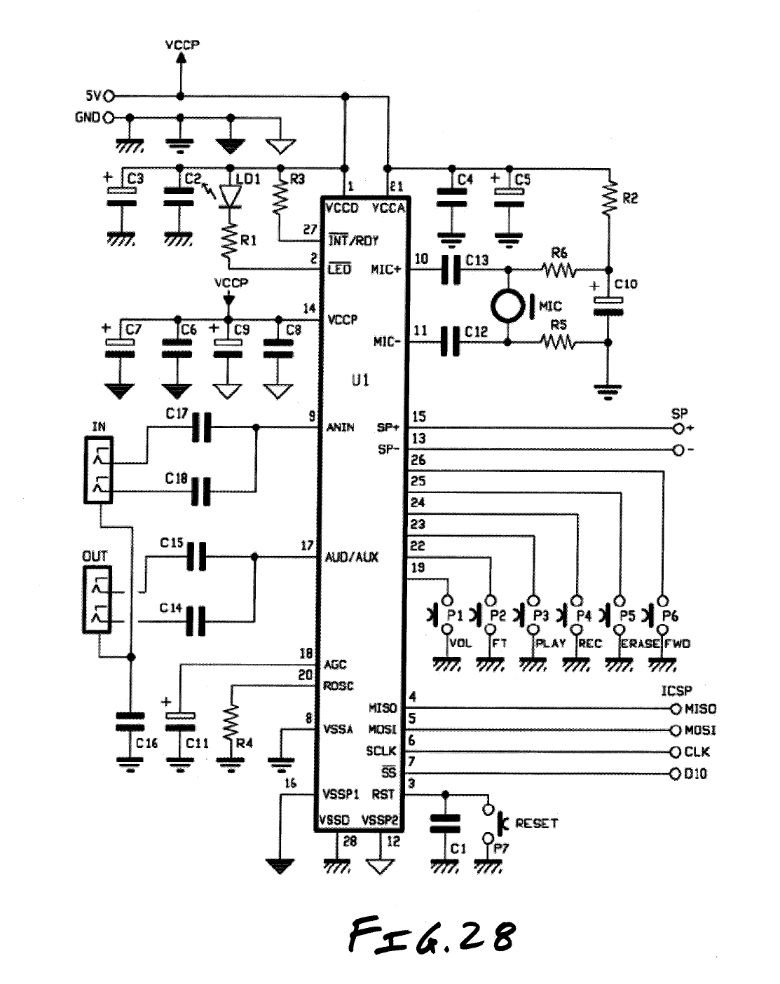

FIG. 26 is an electronic control unit of one embodiment of the present invention that delivers an auto adjustable frequency to the positive and negative polarization modules shown in FIG. 27. This component may replace the components of FIG. 22 and FIG. 25 in the present invention and distributes the frequencies to each transistor line.

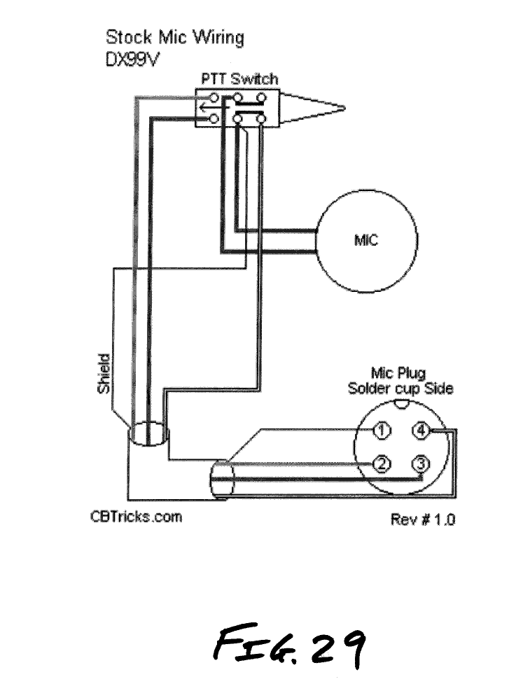

FIG. 28 is a frequency recorder that couples to the microphone input of a civil band radio module in the present invention. FIG. 29 shows that in one embodiment, the frequency recorder is interconnected to the input of the radio.

Although some figures described herein include dimensions, one or ordinary skill in the art will appreciate the size and shape of the disclosed components may be altered to fit a particular need.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A system for producing hydrogen, comprising:
a fluid receptacle;
a water source associated with the fluid receptacle;
a hydrogen storage tank associated with the fluid receptacle;
an electro-magnetic resonance generation device, comprising:
a first closing plate;
a second closing plate;
a plurality of fasteners interconnecting the first closing plate to the second closing plate;
a plurality of negative resonance plates positioned between the first closing plate and the second closing plate;
a plurality of negative polarization plates positioned between the first closing plate and the second closing plate;
a plurality of positive resonance plates positioned between the first closing plate and the second closing plate;
a plurality of positive polarization plates positioned between the first closing plate and the second closing plate;
a plurality of neutral resonance plates positioned between the first closing plate and the second closing plate;
a plurality of neutral polarization plates positioned between the first closing plate and the second closing plate;
a plurality of positive polarization induction wires interconnected to the plurality of positive polarization plates;
a plurality of negative polarization induction wires interconnected to the plurality of negative polarization plates;
a plurality of positive resonance induction wires interconnected to the plurality of positive polarization plates;
a plurality of negative resonance induction wires interconnected to the plurality of negative polarization plates;
a plurality of neutral wires interconnected to the plurality of neutral plates;
a plurality of body portions position between each of the polarization and resonance plates;
an electrical control unit interconnected to the positive polarization wires, the positive resonance wires, negative polarization wires, negative resonance wires, and the neutral wires;
a power source interconnected to the electrical control unit;
wherein the electrical control unit directs the electro-magnetic resonance generation device to vibrate at a predetermined frequency, and wherein the predetermined frequency decomposes the water surrounding the electro-magnetic resonance generation device into hydrogen and oxygen; and
wherein the generated hydrogen is collected in the hydrogen tank.

2. The system of claim 1, wherein the power source comprises a battery used to initiate hydrogen production, and a generator that uses a portion the generated hydrogen to generate electricity to support continued hydrogen production.

3. The system of claim 1, wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires.

4. The system of claim 1, wherein the first closing plate includes an aperture that allows water to enter the electro-magnetic resonance generation device, and wherein the second closing plate includes an aperture.

5. The system of claim 1, wherein the body portion includes a plurality of apertures configured to allow fluid to pass through the electro-magnetic resonance generation device.

6. The system of claim 1, wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area.

7. The system of claim 1, wherein the plurality of fasteners comprise a plurality of outer fasteners that directly interconnect the first closing plate to the second closing plate, and plurality of inner fasteners that interconnect the first closing plate, the plurality of inner fasteners being positioned within corresponding apertures in the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area, and the plurality of inner fasteners being positioned within corresponding apertures in the plurality of body portions.

8. The system of claim 1, wherein:
the plurality of negative resonance plates comprise four plates that vibrate at a frequency of between about 27,000 to about 28,0000 MHz;
the plurality of positive resonance plates comprise three plates that vibrate at a frequency of between about 26,000 to about 27,0000 MHz; and
the plurality of neutral resonance plates comprise two plates that vibrate at a frequency of between about 28,0000 MHz.

9. The system of claim 1, wherein the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device.

10. The system of claim 9, wherein the apertures are octagonal in shape.

11. A system for producing hydrogen, comprising:
a fluid receptacle;
a water source associated with the fluid receptacle;
a hydrogen storage tank associated with the fluid receptacle;
an electro-magnetic resonance generation device submerged in the fluid receptacle, comprising:
a first closing plate;
a second closing plate;
a plurality of negative resonance plates, a plurality of negative polarization plates, a plurality of positive resonance plates, a plurality of positive polarization plates, a plurality of neutral resonance plates, a plurality of neutral polarization plates positioned between the first closing plate and the second closing plate;
a plurality of positive polarization induction wires interconnected to the plurality of positive polarization plates;
a plurality of negative polarization induction wires interconnected to the plurality of negative polarization plates;
a plurality of positive resonance induction wires interconnected to the plurality of positive polarization plates;
a plurality of negative resonance induction wires interconnected to the plurality of
negative polarization plates;
a plurality of neutral wires interconnected to the plurality of neutral plates;
a plurality of body portions position between each of the polarization and resonance plates;
an electrical control unit interconnected to the positive polarization wires, the positive resonance wires, negative polarization wires, negative resonance wires, and the neutral wires; and
a power source interconnected to the electrical control wires.

12. The system of claim 11, wherein the power source comprises a battery used to initiate hydrogen production, and a generator that uses a portion the generated hydrogen to generate electricity to support continued hydrogen production.

13. The system of claim 11, wherein the plurality of negative resonance plates, the plurality of negative polarization plates, the plurality of positive resonance plates, the plurality of positive polarization plates, a plurality of neutral resonance plates, and the plurality of neutral polarization plates each include a tab that interfaces with the positive polarization induction wires, the negative polarization induction wires, the positive resonance induction wires, the negative resonance induction wires, or the neutral wires.

14. The system of claim 11, wherein the first closing plate includes an aperture that allows water to enter the electro-magnetic resonance generation device, and wherein the second closing plate includes an aperture.

15. The system of claim 11, wherein the plurality of body portions have an outer periphery of a first width and an inner area of a second width, the second width being less than the first width, the second width having an upper surface and a lower surface that engage one of the plurality of negative resonance plates, the plurality of negative polarization plates, the plurality of positive resonance plates, the plurality of positive polarization plates, a plurality of neutral resonance plates, and the plurality of neutral polarization plates each include apertures configured to allow fluid to pass through the electro-magnetic resonance generation device, wherein the plate is spaced from the inner area.

16. A method of producing hydrogen, comprising:
introducing water to a reservoir;
feeding water to a cell tower;
using the cell tower to initiate atomic polarization of the water by magnetic induction;
using the cell tower to separate water molecules into hydrogen atoms and oxygen atoms by frequency induction;
separating the hydrogen atoms and the oxygen atoms with a magnetic field generated by the cell tower; and
transferring hydrogen items to a storage tank.

17. The method of claim 16, wherein the oxygen atoms are stored in a second storage tank.

18. The method of claim 16, further comprising directing the hydrogen items to a generator that uses the hydrogen to produce electricity that is directed to the cell tower.

19. The method of claim 16, wherein the frequency induction is generated by vibrational energy emanating from the cell tower, the vibrational energy being controlled by an electronic control unit associated by the cell tower.

20. The method of claim 16, wherein the water is continuously direct to the cell tower, and wherein hydrogen production is on-demand.
